(19) United States
(12) Patent Application Publication
(10) Pub. No.: US 2020/0125200 A1
(43) Pub. Date: Apr. 23, 2020

(54) Touchscreen monitor using Ethernet remote framework

(71) Applicant: CRESTRON ELECTRONICS, INC., ROCKLEIGH, NJ (US)

(72) Inventor: Eugene Yin, Closter, NJ (US)

(73) Assignee: CRESTRON ELECTRONICS, INC., ROCKLEIGH, NJ (US)

(21) Appl. No.: 16/163,972

(22) Filed: Oct. 18, 2018

(51) Int. Cl. G06F 3/041; H04N 21/422; G06F 9/44; G06F 3/0482; G06F 3/0488

(52) U.S. Cl. CPC G06F 3/0412; H04N 21/42207; H04N 21/42224; G06F 3/0482; G06F 3/0488; G06F 9/44

(57) ABSTRACT

A touch screen running a client computer program connects to a remote computer that runs a server computer program and has been adapted to control audio-video equipment using a set of audio-video device specific commands, allowing the touch screen to transmit both touch events and audio-video device specific commands to the remote computer and for the touch screen to receive video frames from the remote computer.

### BACKGROUND OF THE INVENTION

### Technical Field

The present invention relates to an apparatus and method for using a touchscreen to control and monitor a remote computer, which is connected via an Ethernet connection.

### Background Art

The combination of a client application running on a first computer, such as a standard Microsoft Windows application running on a personal computer (PC), which is used to control a second computer running a server application would be known to one skilled in the art as ‘remote management’ system.

The inventors investigated the use of existing remote management systems for suitability as a user interface for commercial and residential automation control products, such as those offered for sale by Crestron Electronics, Inc. During this investigation, the inventors discovered that existing remote management systems such as Microsoft Remote Desktop proved to be unsuitable for such an application for several reasons. Based on this research, the inventors were able to determine that in order to be suitable for use with commercial and residential automation control products, a remote management system would need the following characteristics:
Low latency and high performance
Automatic reconnection upon PC reboot or connection lost
Support product-specific smart commands from client to PC
Allow both remote client and local PC display to view the same contents simultaneously for live trouble shooting
Secure to transport layer security (TLS) version 1.2, or later, for client-server communication
Support for connection authentication
Support server address book created locally or deployed by administrator (admin)

One of the existing remote management systems, Virtual Network Computing (VNC) is an open source computer program that provides a graphical desktop sharing system that uses the Remote Frame Buffer protocol (RFB) to remotely control another computer.

Today, with LAN speeds of 1 GBps or higher, HDMI over LAN provides the possibility of connecting a relatively large number of screens through the same local area network with HDMI, VGA and DVI connections. (Also known as: ‘VGA over LAN’ or ‘DVI over LAN’).

### SUMMARY OF THE INVENTION

It is to be understood that both the general and detailed descriptions that follow are exemplary and explanatory only and are not restrictive of the invention.

### Disclosure of Invention

Just like the traditional VGA/HDMI/DP monitor or USB touchscreen, eTouchscreen client needs to be able to connect to the PC and display the output contents from PC once the touchscreen and PC are powered up and physically connected directly or indirectly via an Ethernet switch. In addition to supporting most of the Remote Management features, more efforts are needed to make the eTouchscreen behave like a traditional monitor plus other advanced Ethernet specific features such as waking up the PC from deep sleep (S3) and hibernate (S4) states via WoL. The first application of eTouchscreen solution would be turning the Mercury or TSW touch screen into an eTouchscreen for Rigel PC to server as the Rigel controlling console.

Crestron Remote enables an IT help desk to remotely view Crestron device's display output and control it via a secure channel. Advantageously, the inventive features that are incorporated into Crestron Remote can be incorporated into many products running Windows or Android operating systems.

Crestron Remote is similar in function to the open source application VNC and Microsoft Remote Desktop. Crestron Remote, however, utilizes inventive technology and thus provides better performance. More specifically, Crestron Remote provides additional required features that neither VNC nor Microsoft Remote Desktop offers. More specifically, Crestron Remote provides the following features:

Features
Government compliant secure connection and communication
Be able to remotely log on the device's admin mode
Use the same credentials assigned to the Crestron product for connection
Be able to automatically reconnect to the device after device reboots
Allow the device to be continuously utilized locally while remote connection is active
Allow issue Crestron device specific commands

Sleep states for a personal computer (PC) are defined by the Advanced Configuration and Power Interface (ACPI) specification as shown in the table below. System level power states are denoted S0-S5. Higher S-numbers indicate deeper levels of sleep. The table below helps define the states:

| Sleeping | |
|---|---|
| State | Description |
| S0 | Awake |
| S1 | Low wake latency sleeping state. No system context is lost, |
| | hardware maintains all context. |
| S2 | Similar to S1 but CPU and system cache context is lost |
| S3 | All system context is lost except system memory (CPU, |
| | cache, chipset context all lost). |
| S4 | Lowest power, longest wake latency supported by ACPI. |
| | Hardware platform has powered off all devices, platform |
| | context is maintained. |
| S5 | Similar so S4 except OS does not save any context, |
| | requires complete boot upon wake. |

Support H.264 encoding and decoding and RTSP protocol for communication to be consistent with Crestron streaming standard

High number of frames-per-second (fps) and low latency

As indicated in Table 1, both VNC (Open Source software) and Microsoft Remote Desktop only partially meet the above requirements.

One skilled in the art would recognize that certain remote desktop functionality can be provided by Remote Desktop functionality as shown in the table below.

| | VNC | Microsoft Remote |
|---|---|---|
| Feature | (open source) | Desktop |
| Government compliant secure | No | Yes |
| connection and communication | | |
| Be able to remotely log on the | Yes | No |
| device's admin mode | | |
| Use the same credentials assigned | No | Yes |
| to the Crestron device for connection | | |
| Allow Device to Continue Function | Yes | No |
| upon Client's Connection | | |

There is a long-felt need to provide additional remote desktop functionality, for example

| | | Microsoft | |
|---|---|---|---|
| | VNC | Remote | Crestron |
| Feature | (Open Source) | Desktop | Remote |
| Be able to | No | No | Yes |
| automatically | | | |
| reconnect to the | | | |
| device after device | | | |
| reboots | | | |
| Allow issuing | No | No | Yes |
| Crestron device | | | |
| specific commands | | | |
| Support H.264 | No | No | Yes |
| encoding and | | | |
| decoding and RTSP | | | |
| protocol for | | | |
| communication to be | | | |
| consistent with | | | |
| Crestron streaming | | | |
| standard | | | |
| High FPS and low | High latency and | High latency | 24-30 fps |
| latency | sloppy most of the | | and low |
| | time | | latency of |
| | | | 150-300 ms |

HDMI and DP monitors are the most popular display devices. Most of these devices don't support touch. Some monitors support touch, but a separate USB connection is needed between the display and the PC. Both display and USB cables are limited to relative short length without noticeable signal drop.

The emerging USB touch screen offers both video display and touch support with a single USB cable. Again the USB cable is limited to short lengths unless extra hardware is used to extend the cable length.

### BRIEF DESCRIPTION OF DRAWINGS

The accompanying figures further illustrate the present invention. Exemplary embodiments are illustrated in reference figures of the drawings. It is intended that the embodiments and figures disclosed herein are to be considered to illustrative rather than limiting.

The components in the drawings are not necessarily drawn to scale, emphasis instead being placed upon clearly illustrating the principles of the present invention. In the drawings, like reference numerals designate corresponding parts throughout the several views.

### BRIEF DESCRIPTION OF THE SEVERAL VIEWS OF THE DRAWING

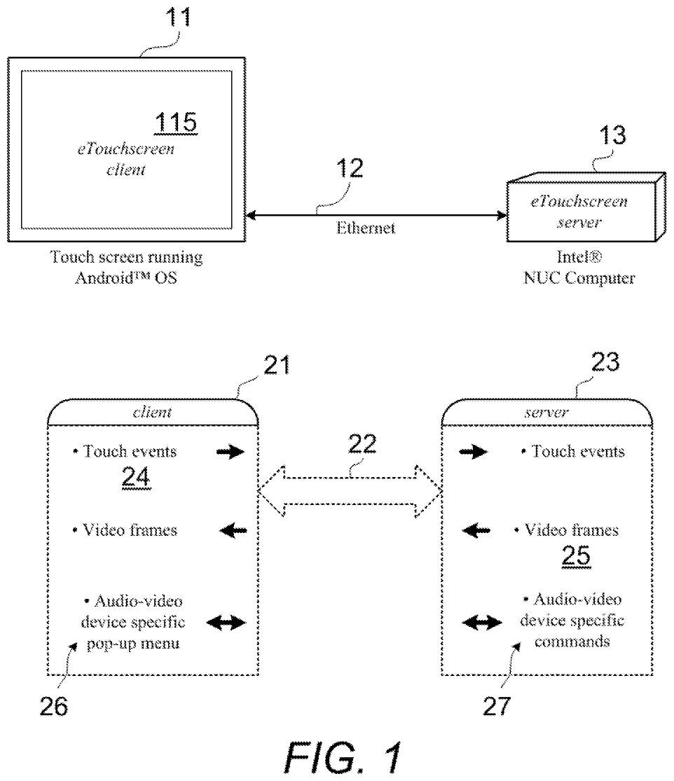

FIG. 1 shows a Crestron Remote client-server communications flow-chart in accordance with one illustrative embodiment of the present invention.

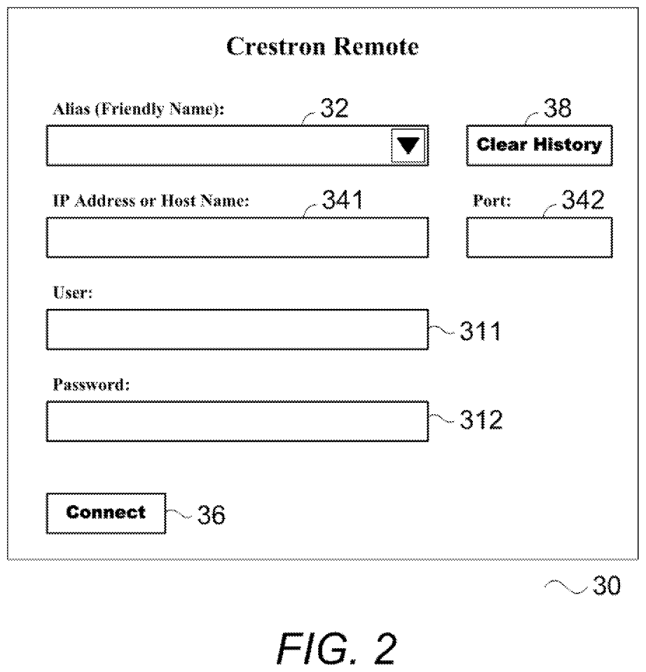

FIG. 2 depicts a Crestron Remote Client Startup screen user interface that is suitable for use the embodiment shown in FIG. 1.

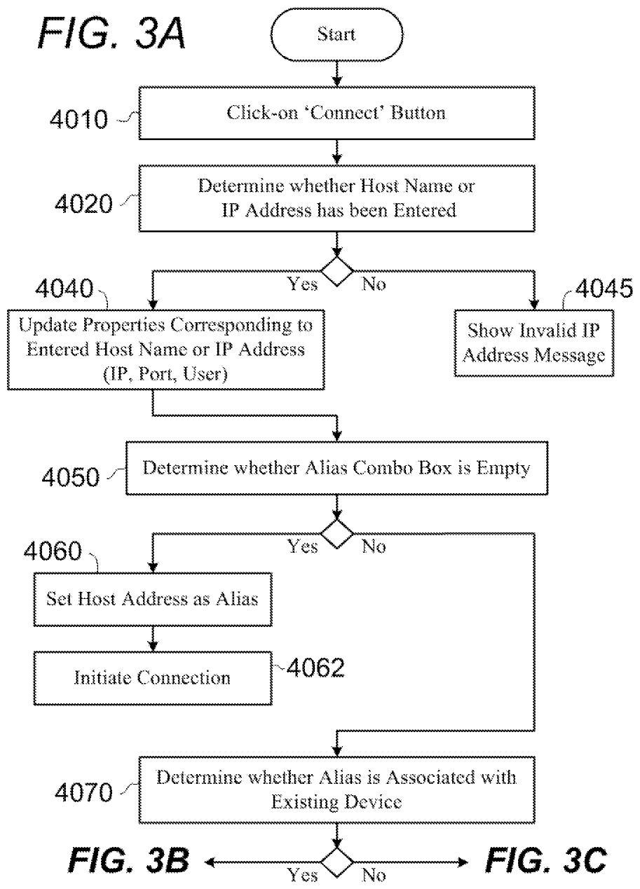

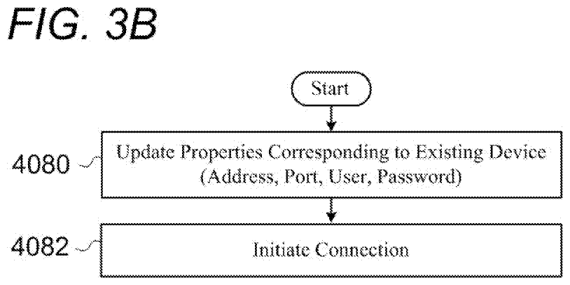

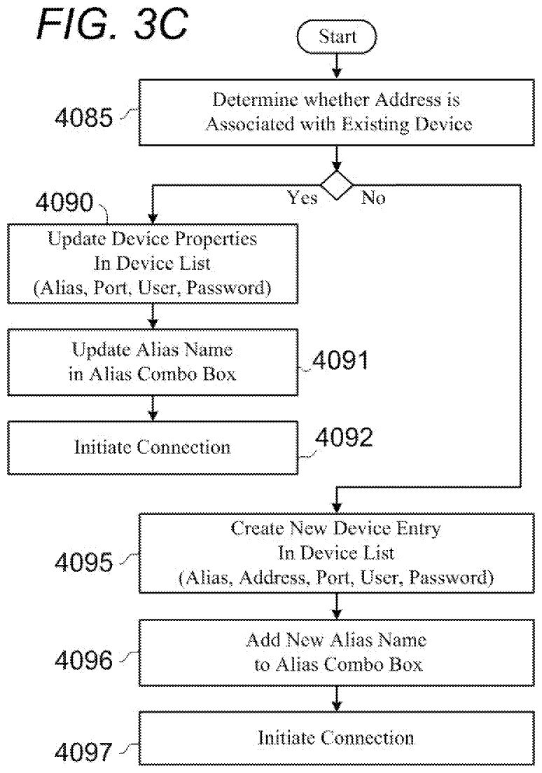

FIGS. 3A-3C show a method of connecting a client application in a touch screen device with a server application running in a remote computer in accordance with the present invention.

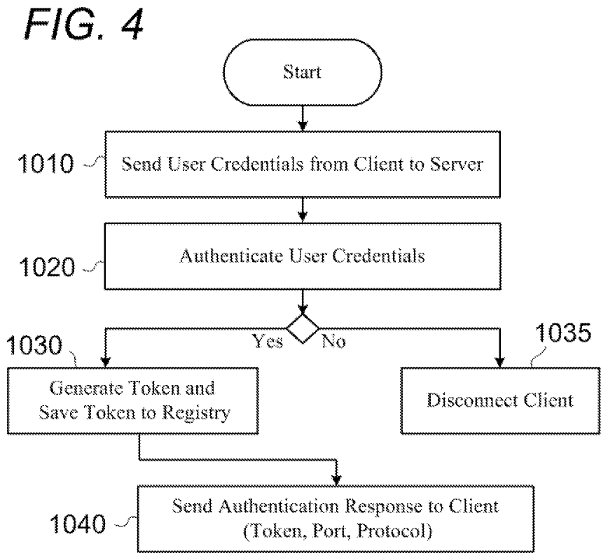

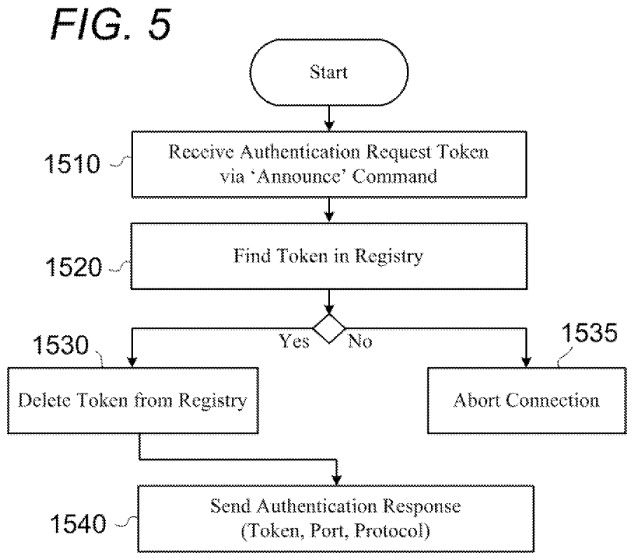

FIGS. 4 and 5 show a method of authenticating a client application to a server application running in a remote computer suitable for use with the present invention.

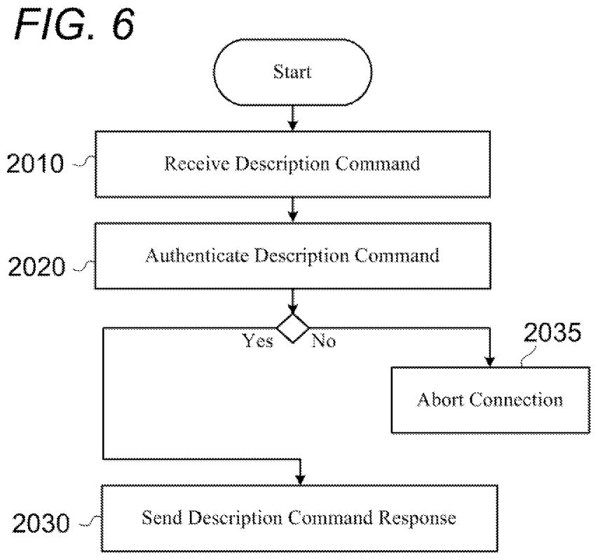

FIG. 6 shows a method of receiving and authenticating a description command suitable for use with the present invention.

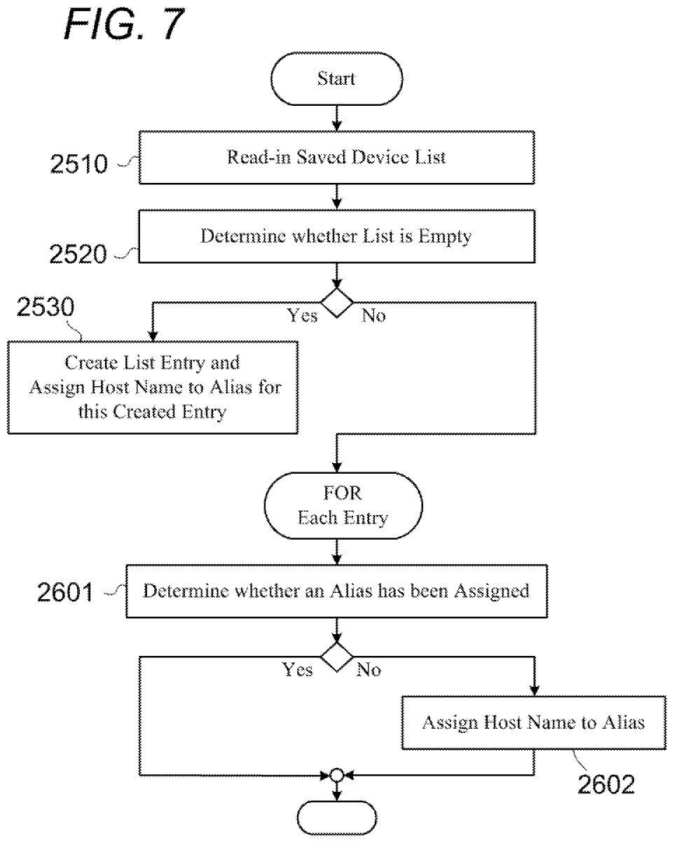

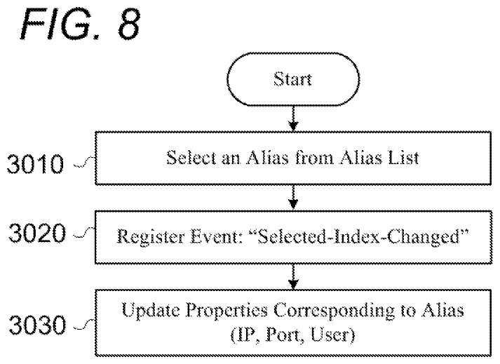

FIGS. 7-9 show methods of receiving alias names and updating properties based on such alias names suitable for use with the present invention.

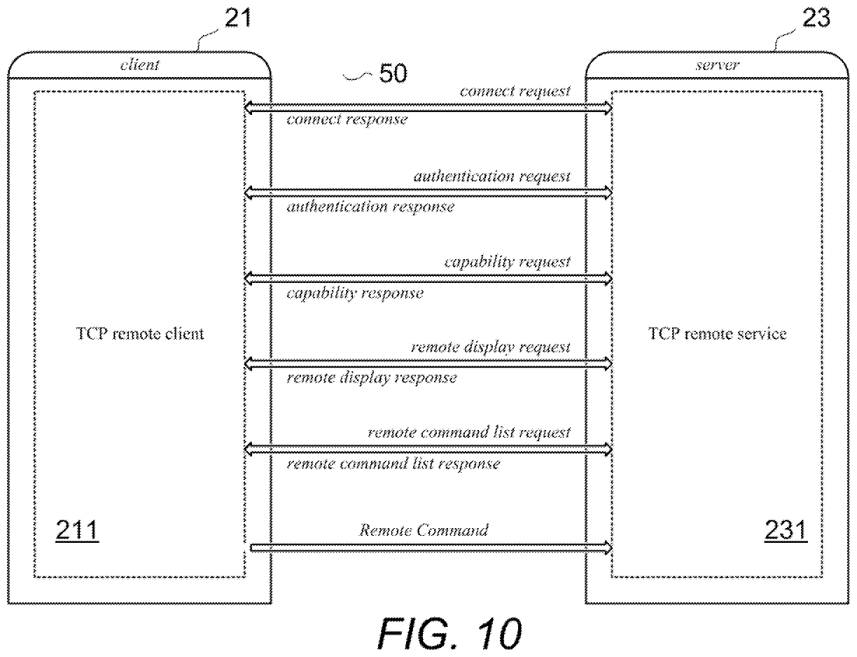

FIG. 10 illustrates the network communication between a client and a server using terminal control protocol in accordance with the present invention.

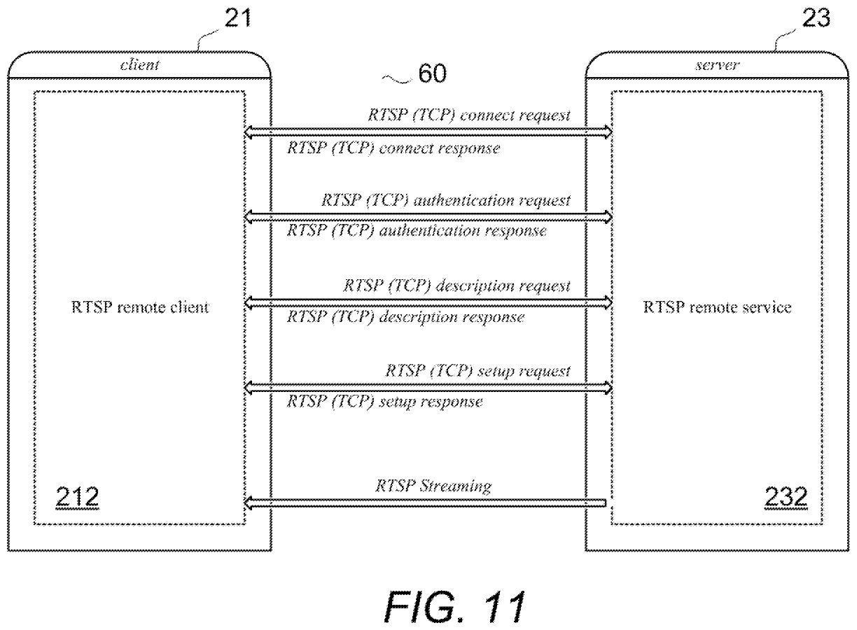

FIG. 11 illustrates the network communication between a client and a server using real time streaming protocol in accordance with the present invention.

### LIST OF REFERENCE NUMBERS FOR THE MAJOR ELEMENTS IN THE DRAWING

The following is a list of the major elements in the drawings in numerical order.

touch screen (running client application 21)

11 Ethernet (network connection)

13 appliance computer (running server application 31)

21 client (computer program running on touch screen 11)

22 ‘smart’ communication channel (between client 21 and server 23)

23 server (computer program running on appliance computer 13)

26 pop-up menu (of audio-video device specific commands 27)

27 audio-video device specific commands (supported by appliance computer 13)

30 user interface (displayed on touch screen 11)

32 alias combo box (p/o user interface 30)

36 connect button (p/o user interface 30)

38 clear history button (p/o user interface 30)

50 first connection channel (between client 21 and server 23)

60 first connection channel (between client 21 and server 23)

115 remote display (p/o touch screen 11)

311 user name combo box (p/o user interface 30)

312 password combo box (p/o user interface 30)

341 IP address or host name combo box (p/o user interface 30)

342 IP port combo box (p/o user interface 30)

1010 (step of) sending user credentials from client to server

1020 (step of) authenticating user credentials (at server)

1030 (step of) generating a token and saving that token to registry

1035 (step of) disconnecting client

1040 (step of) sending authentication response to client (from server)

1510 (step of) receiving authentication request token (at server)

1520 (step of) finding token in registry (at server)

1530 (step of) deleting token from registry (at server)

1535 (step of) aborting connection (between client and server)

1540 (step of) sending authentication response to client (from server)

2010 (step of) receiving description command (at server)

2020 (step of) authenticating description command (at server)

2030 (step of) sending description command response

2035 (step of) aborting connection (between client and server)

2510 (step of) reading in a saved device list

2520 (step of) determining whether saved device list is empty

2530 (step of) creating a saved device list entry and assigning a host name to alias (for this entry)

2601 (step of) determining whether an alias has been assigned (for each list entry)

2602 (step of) assigning a host name to an alias (for each list entry)

3010 (step of) selecting an alias from the alias list

3020 (step of) registering an event (“selected-index-changed”)

3030 (step of) updating properties corresponding to alias

3510 (step of) typing in a new alias (by end-user)

3520 (step of) registering an event (“selected-index-changed”)

3530 (step of) determining whether new alias name is in alias list

3540 (step of) updating properties corresponding to alias

4010 (step of) clicking on connect button (by end-user)

4020 (step of) determining whether host name or IP address has been entered

4040 (step of) updating properties corresponding to entered host name or IP Address

4045 (step of) showing invalid IP address message

4050 (step of) determining whether alias combo box is empty

4060 (step of) setting host address as alias

4062 (step of) initiating connection (between client and server)

4070 (step of) determining whether alias is associated with existing device

4080 (step of) updating properties corresponding to existing device

4082 (step of) initiating connection (between client and server)

4085 (step of) determining whether address is associated with existing device

4090 (step of) updating device properties in device list

4091 (step of) updating alias name in alias combo box

4092 (step of) initiating connection (between client and server)

4095 (step of) creating new device entry in device list

4096 (step of) adding new alias name to alias combo box

4097 (step of) initiating connection (between client and server)

### DETAILED DESCRIPTION OF THE INVENTION

The present invention is generally implemented as part of a networked computer system including a touch screen device that is located remotely form a computer that is under its control. Hence, such an illustrative networked computer system and its operation will be described initially.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### Mode(s) for Carrying Out the Invention

The preferred embodiment of the present invention is described herein in the context of a wall-mounted touchscreen device controlling a, but is not limited thereto, except as may be set forth expressly in the appended claims.

Refer now to FIG. 1, which shows the communication workflow between client and server applications.

Crestron Remote includes Crestron proprietary applications on both server (Crestron products) and client (help desk PCs and tablets) sides. Two parent applications, CrestronRemoteClient on client side and CrestronRemoteService on server side, are responsible for product access authentication, configuration, as well as mouse and keyboard controlling. Each parent application owns a child application responsible for streaming the device display output to the client.

More specifically, FIG. 1 shows an illustrative embodiment of the present invention in the context of the Crestron eTouchscreen project, which involves the use of a touch screen 11 device, such as a device that runs the well-known Android™ operating system (OS) that is connected to an appliance computer 13, such as the PC-compatible computer Intel® NUC Computer over an Ethernet 12 network connection. In this embodiment, the present invention involves the use of a server 23 MS-Windows-based computer program running on the appliance computer 13 and a client 21 computer program running on the Android™-based touch screen 11. In other embodiments of the present invention, touchscreens running the MS-Windows operating system or other operating systems are used. In even other embodiments, the appliance computer 13 is based on another operating system, such as Linux.

FIG. 1 also shows a smart communication channel 22 that is established between the client 21 and server 23. Through this channel 22, the server sends the client a list of supported ‘smart’ audio-video device specific commands 27 when the connection is established. The client exposes these commands 27 to the user via a local pop-up menu 26 on the touch screen 11 to perform desired tasks. Advantageously, the use of ‘smart’ audio-video device specific commands 27 and pop-up menu 26 are especially useful when the appliance computer 13 is a locked-down consumer PC appliance for which no system menu is exposed to an end-user.

Once connected by the client 11, the server 13 will send the client a list of product specific commands 27 it supports. The user can then trigger these commands 27 via a local pop-up menu 26 on the touch screen 11. These commands 27 are crucial to manage a locked-down consumer appliance PC where no system menu is exposed.

Intelligent logic is built into the client 21 and server 23 applications to ensure prompt connection and reconnection and provide informative end-user notification. The client 21 can be configured to connect to a target appliance computer 13 with a static IP address once the touch screen 11 is powered up. It can also discover the target appliance computer 13 based on its hostname via a proprietary (alias) discovery protocol. Advantageously, automatic connection is always guaranteed whether there is a direct cable link between the touch screen 11 and the appliance computer 13 or they are connected via an Ethernet switch on a local area network (LAN).

When the appliance computer 13 cold starts, the server application 23 broadcasts an online message to all devices that are connected to the appliance computer 13, such as by a LAN. Once the client application 21 gets this message and recognizes that it is from the preconfigured appliance computer 13, it will connect to it immediately.

When the appliance computer 13 is about to reboot, the server 23 will send a notification to the client 21. Upon receiving this message, the client 21 will display an informative message on the display 115 of the touch screen 11. Similarly, when the appliance computer 13 is going into sleep or hibernate state, the client 21 will put itself into sleep mode as well upon receiving this notification.

By accurately tracking the state of the server application 23 that is hosted on the appliance computer 13, the client application 21, running on the touch screen 11 can properly wake up the appliance computer 13. While the appliance computer 13 is standby mode, touching on the display screen 115 or activation of the occupancy sensor on the touch screen 11 will trigger a touch message being sent to the appliance computer 13 to wake it up. If the appliance computer 13 is in deep sleep (S3) or hibernate (S4) mode the client 21 would send a magic WoL packet to the appliance computer 13 to wake it up and then reconnect to the appliance computer 13. Note that WoL from hybrid shutdown or fully powered off states is not supported for an appliance computer 13 running Windows 8 or above because users of these operating systems expect zero power consumption and battery drain in shutdown state.

Refer now to FIG. 2, which shows an example user interface (UI) 30, displayed on the touch screen 11 and used by an end-user to enter parameters required to establish a network connection between client 21 and server 22. When the client application 21 starts, it will prompt the end-user for connection information. The client application then saves the connection information for later use when communication channel 22 is established. The workflow associated with communication channel 22 is indicated in FIGS. 10 and 11.

In one exemplary embodiment, the client user interface 30 will start up at the resolution of 1280×800 pixels. The user can maximize the application window to full screen and then restore it to the original size. The view aspect ratio of the target system output is always maintained. So, depending on size of the client window one may see black band on left and right sides or top and bottom sides.

All mouse and keyboard messages, collectively ‘touch events’ 24, targeted to the client application 21 will be captured and sent to the remote service 23 running on the appliance computer 13 for controlling the appliance computer 13. Upon receiving the touch events 24 (mouse and keyboard messages), the remote service 23 will inject them into the local operating system, which subsequently routes the messages to the current foreground window. To the foreground window, these injected input messages are no different from those triggered via an external physical mouse and keyboard. It should be noted that, in order to activate the remote mouse and keyboard controlling, the client application must have focus and the mouse activities must be within the client application 21 client area.

The client 21 captures all touch events 24 from the touch screen 11 and sends these events over to the server 23. These touch events 24 are then injected into the operating system of the appliance computer 13 by the server 23 and processed by the operating system in a similar fashion as it does with the local touch events.

Intelligent logic is built into both client 21 and server 23 applications to ensure prompt connection once the appliance computer 13 and/or touch screen 11 starts up or physically connected just like a traditional video monitor does. In addition, informative notifications are displayed on the touch screen 11 display 115 whenever appropriate to inform the user of the appliance computer 13 state, connection status, as well as trouble shooting suggestions.

The client 21 can wake up the appliance computer 13 from standby mode when the user touches on the touch screen 11 display 115 or alternatively, when for example, an occupancy sensor on the touch screen 11 is activated. In addition, the client 23 can also wake up the appliance computer 13 from deep sleep (S3) or hibernation (S4) states by sending the magic Wake-On-LAN (WoL) packet. Note that WoL from hybrid shutdown or fully powered off states is not supported for an appliance computer 13 running Windows 8 or above because the associated end-users expect zero power consumption and battery drain in shutdown state.

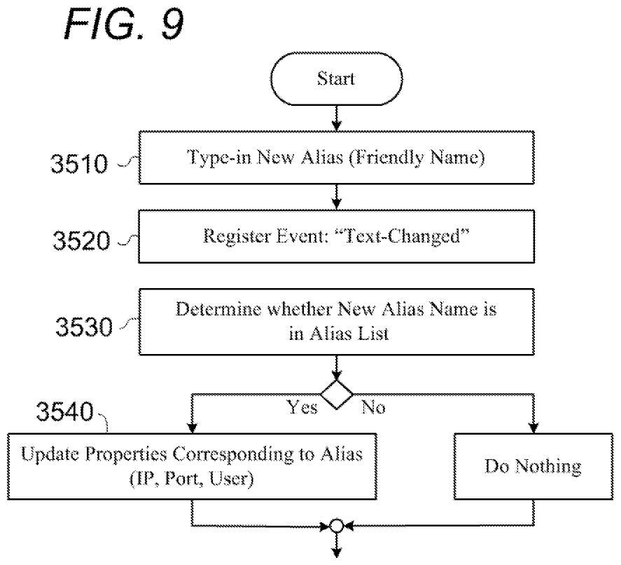

Refer now to FIGS. 1 and 2 and also to FIG. 9A. When the connect button 36 is clicked (step 4010), the client 11 application will use the information provided by the user to connect to the remote service via terminal control protocol (TCP). For example, in one illustrative embodiment, port number “49500” can be shown/ entered into the port combo box 342 for use in establishing the network connection. For embodiments of the present invention based on the use of equipment provided by Crestron Electronics, Inc., different port numbers can be configured via Toolbox console commands, such as “CRPort”.

Refer now to FIG. 10. Upon connection, the client 11 and server 12 will go through a series of hand shaking steps for client authentication, as shown in FIGS. 4-9 and to identify device capability and supported commands as well streaming and controlling protocols. The streaming client 212, shown in FIG. 11, will then be instantiated to connect to the streaming server 232, also shown in FIG. 11, running on the appliance computer 13 to allow for the remote display of the appliance computer 13 video output.

As shown in FIG. 11, a real time streaming protocol (RTSP) session will be initiated using either terminal control protocol (TCP) or user datagram protocol (UDP) can be configured for the streaming. In one embodiment, a default port number 49501 will be utilized for RTSP over TCP, and default port numbers 6970 and 6971, respectively, will be used for RTSP over UDP.

In a preferred embodiment of the present invention, when the top-level connection port is changed, such as via a Crestron Toolbox console command “CRPort” then the RTSP over TCP port number will automatically be changed to 1 plus the newly changed port number. For example, if the CRPort command assigns a port number 50000, then the RTSP over TCP port number will automatically become 50001.

According to the present invention, authentication is performed using a scheme, which is based on the administrator (admin) credentials assigned to the product by an end-user. For example, the credentials can be based on either a local admin account or a domain account. The authentication credentials provided by the user are sent to the remote service via a secure channel. The authentication request and response packets are detailed byte-by-byte in Tables 2 and 3, shown below.

TABLE 2
Authentication Request Packet

| | Type | Size |
|---|---|---|
| Header | Packet type | 1 byte |
| | Transition number | 1 byte |
| | Flags | 2 bytes |
| | Packet size | 2 bytes |
| Data | User name char count | 2 bytes |
| | User name | 2 bytes |
| | Password char count | 2 bytes |
| | Password | string |

TABLE 3
Authentication Response Packet

| | Type | Size |
|---|---|---|
| Header | Packet type | 1 byte |
| | Transition number | 1 byte |
| | Flags | 2 bytes |
| | Packet size | 2 bytes |
| Data | Secure token char count | 2 bytes |
| | Secure token string | String |
| | Port number | 4 bytes |
| | Protocol (UDP = 0x01; TCP = 0x02) | 2 bytes |

Likewise, capability of the remote service is determined using a request-response scheme. The capability request and response packets are detailed byte-by-byte in Tables 4 and 5, shown below.

TABLE 4
Capability request packet

| | Type | Size |
|---|---|---|
| Header | Packet type | 1 byte |
| | Transition number | 1 byte |
| | Flags | 2 bytes |
| | Packet size | 2 bytes |
| Data | Version string char count | 2 bytes |
| | Version | string |

TABLE 5
Capability response packet

| | Type | Size |
|---|---|---|
| Header | Packet type | 1 byte |
| | Transition number | 1 byte |
| | Flags | 2 bytes |
| | Packet size | 2 bytes |
| Data | Product name string char count | 2 bytes |
| | Product name string | string |
| | Version string char count | 2 bytes |
| | Version string | string |
| | Capability | 8 bytes |
| | (None = 0x00; CfgRemoteDP = 0x01; | |
| | HandleCmd = 0x02; MultiLanguage = 0x04; | |
| | Reserved2 = 0x08; Reserved3 = 0x10; | |
| | Reserved4 = 0x20; Reserved5 = 0x40; | |
| | Reserved6 = 0x80) | |

The number of displays and the display names associated with the remote service is also determined using a request-response scheme. The display output request and response packets are detailed byte-by-byte in Tables 6 and 7, shown below.

TABLE 6
Remote Display Output Request Packet

| | Type | Size |
|---|---|---|
| Header | Packet type | 1 byte |
| | Transition number | 1 byte |
| | Flags | 2 bytes |
| | Packet size | 2 bytes |
| Data | Previously selected display output string char | 2 bytes |
| | count | |
| | Previously selected display output string | string |

TABLE 7
Remote Display Output Response Packet

| | Type | Size |
|---|---|---|
| Header | Packet type | 1 byte |
| | Transition number | 1 byte |
| | Flags | 2 bytes |
| | Packet size | 2 bytes |
| Data | Primary display output string char count | 2 bytes |
| | Primary display output string | string |
| | Total number of displays | 2 bytes |
| | 1^{st} display name char count | 2 bytes |
| | 1^{st} display name | string |
| | . . . | |
| | Last display name char count | 2 bytes |
| | Last display name | string |

Command lists are exchanged with the remote service by using a request-response scheme. The remote command list request and response packets are detailed byte-by-byte in Tables 8 and 9, shown below.

TABLE 8
Remote Command List Request Packet

| | Type | Size |
|---|---|---|
| Header | Packet type | 1 byte |
| | Transition number | 1 byte |
| | Flags | 2 bytes |
| | Packet size | 2 bytes |
| Data | No data payload | |

TABLE 9
Remote Command List Response Packet

| | Type | Size |
|---|---|---|
| Header | Packet type | 1 byte |
| | Transition number | 1 byte |
| | Flags | 2 bytes |
| | Packet size | 2 bytes |
| Data | Command count | 2 bytes |
| | 1^{st} command name char count | 2 bytes |
| | 1^{st} command name | string |
| | . . . | |
| | Last command name char count | 2 bytes |
| | Last command name | string |

In a preferred embodiment, all TCP communications, via the Internet, are over a secure channel that complies with the Federal Information Processing Standard (FIPS). For intranet usage, non-secure RTSP over UDP can be used in order to reduce overhead associated with encryption and decryption.

Upon receiving the connected display outputs, collectively ‘video frames’ 25, from the appliance computer 13, the client application 21 will dynamically build all display outputs, on the remote display 115, into a top-level display output menu. Once a display output is selected from the menu by the end-user, it will be sent over to the device via a remote command packet. Advantageously, this will allow an end-user the ability to switch and remotely view and control different device outputs.

In one embodiment, the eTouchscreen server 23 is created as a Windows service so it will start once the Windows operating system starts up. The server 23 can be configured to capture the desired display output and the captured video frames 25 are then encoded and streamed out to the client. Both capture and encoding are done by hardware accelerated technologies. The encoded video frames 25 are transferred to the client 21 via the efficient RTSP protocol. Frame throttling mechanisms are built into both server 23 and client 21 to minimize latency.

The touch events 24 are sent to the server 23 from the client 21 via TCP/IP protocol. Depending on the Windows logon state, proper code path is executed to inject the touch events into the operating system for the display output.

Once received by the client 21, the display output video frames 25 are decoded and displayed full screen on the touch screen 11 via hardware accelerated APIs. The client 21 also captures all user touch events 24 and sends them to the server 23 via TCP/IP protocol for processing. In addition, smart logic is built into the client 21 to allow the user to issue audio-video device specific commands 27 to the server 23.

Configuration commands are exchanged with the remote service by using a request-response scheme. The remote command request and response packets are detailed byte-by-byte in Tables 10 and 11, shown below.

TABLE 10
Remote command packet

| | Type | Size |
|---|---|---|
| Header | Packet type | 1 byte |
| | Transition number | 1 byte |
| | Flags | 2 bytes |
| | Packet size | 2 bytes |
| Data | Command type | 2 bytes |
| | Command string char count | 2 bytes |
| | Command | string |

TABLE 11
Remote command feedback packet

| | Type | Size |
|---|---|---|
| Header | Packet type | 1 byte |
| | Transition number | 1 byte |
| | Flags | 2 bytes |
| | Packet size | 2 bytes |
| Data | Command type | 2 bytes |
| | Command string char count | 2 bytes |
| | Command | string |
| | Command feedback | 2 bytes |

Similar to display outputs from the appliance computer 13, the client application 21 will dynamically build all supported commands received from the appliance computer 13 into a top-level Command menu. Once a command is selected from the audio-video device specific menu 26 it will be sent over to the appliance computer 13 via the above remote command packet. Advantageously, this will allow the user to issue audio-video device specific commands 27 to the appliance computer 13 in order to trigger special functionality.

Note that the audio-video device specific commands 27 are defined and processed by the appliance computer 13. The number of commands 27 and the functionalities attached to them are independent of the client application 21. To the client application 21, these commands are just a list of strings passing around between the client application and the appliance computer 13. Advantageously, this design allows new commands to be added to the appliance computer 13 to allow operation of new and different audio-video devices without re-deploying the client application 21.

In one illustrative embodiment of the present invention, the appliance computer 13 display output is captured with Windows API BitBlt. The captured video frame 25 is then encoded into H.264 format and transmitted to the client 21 side via real-time streaming protocol (RTSP).

In one alternate embodiment, where the touch screen 11 is running the Microsoft Windows operating system, upon receiving the captured video stream from the appliance computer 13, the (Crestron Remote) client 21 decodes it using hardware accelerated Microsoft Media Foundation technology. The decoded video frames 25 are then color space converted to red, green, blue, alpha (RGBA) format and rendered to the touch screen 11 display 115 via Microsoft DirectX APIs.

The server 23 can be configured to capture the desired display output of the appliance computer 13. The captured video frames 25 are then encoded and streamed out to the client 23. Once received by the client 23, the video frames 25 are decoded and displayed full-screen on the touch screen 11. The capture, encoding, and decoding are all done via hardware accelerated technologies to achieve low latency, best performance, and operation efficiency.

If for any reason the touch screen loses connection to the PC, the client application 21 will output an informative message on the touch screen 11 to help the end-user trouble shoot the problem. Once the problem is resolved, a recovery mechanism built into the client 21 will allow the touch screen 11 to quickly reconnect to the appliance computer 13.

To ensure that only the dedicated touch screen 11 can connect to the appliance computer 13, connection authentication is provided as shown in FIGS. 4 and 5. Accordingly, the server 23 will only accept a communication channel 2 connection from a client 21 that can provide valid credentials, such as for example, a local login account or a domain account.

In one embodiment, the Crestron eTouchscreen 11 offers both display output and touch support with a single category 5 (Cat 5) Ethernet cable 12. The distance between the touch screen 11 and appliance computer 13 is essentially unlimited, which is an installation advantage. By creating a virtual display output on the appliance computer 13 for connection by the eTouchscreen 11, a physical display connector is not needed, which advantageously simplifies hardware design and reduces cost for developing a future appliance computer 13.

Refer now to FIGS. 10 and 11. There are two connection channels between the client 21 and the server 23. The first connection channel 50 is used for touch messages and special commands/events, and the second connection channel 60 is used for streaming display output video. Both communication channels are secured at TLS 1.2 level.

### INDUSTRIAL APPLICABILITY

To solve the aforementioned problems, the present invention is a unique system in which a remote touchscreen is able to fully emulate a computer monitor, keyboard, and mouse and additionally provide a unique ‘functions’ menu.

### List of Acronyms Used in the Detailed Description of the Invention

The following is a list of the acronyms used in the specification in alphabetical order.

ACPI Advanced Configuration and Power Interface (industry specification)

Admin administrator (typically credentials)

API application programming interface

AV audio-video

BitBlt bit block transfer (computer graphics data operation)

CPU central processing unit (typically an integrated circuit)

CRPort Crestron remote port (command)

DP DisplayPort

DSP digital signal processor

DVI Digital Visual Interface (specification for computer video)

FIPS Federal Information Processing Standard

fps frames per second

H.264 MPEG-4 Part 10, Advanced Video Coding

HDMI High-Definition Multimedia Interface

iOS operating system for Apple IPad and iPhone devices

LAN local area network

MPEG motion picture experts group (standards setting organization)

NUC next unit of computing (small form factor computer by Intel)

OS operating system

PC personal computer

RFB remote frame buffer (protocol)

RGBA red, blue, green, alpha (color format where ‘alpha’ indicates opacity).

RL ‘Room Link’ (Crestron brand name)

RTSP real-time streaming protocol

S0 sleeping state (awake)

S1 sleeping state

S2 sleeping state

S3 sleeping state

S4 sleeping state

S5 sleeping state (requires reboot to awake)

TCP terminal control protocol

TSW touch screen, wall (Crestron part number nomenclature)

UDP user datagram protocol

UI user interface

USB universal serial bus (physical layer specification)

VGA Video Graphics Array (specification for computer video)

VNC Virtual Network Computing

WoL Wake-Up on LAN (computer networking standard)

### Alternate Embodiments

Alternate embodiments may be devised without departing from the spirit or the scope of the invention. For example, the remote touchscreen could also provide audio input and output functionality similar to the well-known speaker and microphone interfaces provided with a personal computer. Also, multiple clients can connect to the same appliance PC simultaneously.

Other advantages of the present invention can also be realized, such as the elimination of distance limits when using the inventive technology with HDMI over LAN zero clients.

What is claimed is:

1. A system for controlling audio-video devices over a remote connection (22) comprising:
(a) a touch screen (11) including a client computer program (21), wherein such client computer program further comprises
(i) a terminal control protocol (TCP) remote client (211) and
(ii) a real-time streaming protocol (RTSP) remote client (212);
(b) an appliance computer (13) being adapted to control audio-video equipment and including a server computer program (23), wherein such server computer program further comprises
(i) a TCP remote service (231) and
(ii) an RTSP remote service (232);
(c) an Ethernet connection (12) between the touch screen and the appliance computer;
(d) wherein a graphical display created by the appliance computer is transmitted from said appliance computer to the touch screen using real-time streaming protocol;
(e) wherein the appliance computer is capable of performing a set of audio-video device specific commands (27); and
(f) wherein the appliance computer maintains a command list that includes entries for each of the audio-video device specific commands.

2. The system of claim 1, wherein the touch screen is adapted to:
(a) automatically reconnect to the appliance computer using the terminal control protocol upon reboot of the appliance computer; and
(b) display a pop-up menu (26) of the audio-video device specific commands.

3. The system of claim 1, wherein the real-time streaming protocol is adapted to provide a relatively high frame-per-second rate and low latency.

4. The system of claim 1, wherein the real-time streaming protocol supports H.264 video encoding and decoding.

5. The system of claim 1, wherein the appliance computer is a locked-down consumer PC appliance for which no system menu is exposed to an end-user.
